(19) United States
(12) Patent Application Publication
(10) Pub. No.: US 2008/0012411 A1
(43) Pub. Date: Jan. 17, 2008

(54) Vehicle seat adjusting assembly

(75) Inventors: Karl R. Kennedy, Fraser, MI (US); Oliver J. Young, Grosse Pointe, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/487,081

(22) Filed: Jul. 14, 2006

(51) Int. Cl. B60N 2/02

(52) U.S. Cl. 297/341

(57) ABSTRACT

A seat adjusting assembly includes a first latch mechanism movable between a disengaged position wherein a vehicle seat bottom is forwardly or rearwardly movable relative to the vehicle floor, and an engaged position wherein the seat bottom is prevented from moving. A second latch mechanism is movable between a disengaged position wherein a seatback of the vehicle seat assembly is forwardly or rearwardly pivotally movable relative to the seat bottom, and an engaged position wherein the seatback is prevented from moving. An actuating mechanism is mechanically connected to the first and second latch mechanisms and is movable between a first actuating position wherein the first latch mechanism is in the disengaged position and the second latch mechanism is in the engaged position, and a second actuating position wherein the second latch mechanism is in the disengaged position and the first latch mechanism is in the engaged position.

### BACKGROUND

Various embodiments of a seat adjusting assembly are described herein. In particular, the embodiments described herein relate to an improved seat adjusting assembly for a vehicle.

Conventional vehicle seats may include a first independent actuation mechanism for moving a seat bottom forwardly and rearwardly relative to the vehicle floor, and a second independent actuation mechanism for moving the seatback pivotally forward and/or rearward relative to the seat bottom. Such a conventional vehicle seat is shown in FIG. 1.

The vehicle seat illustrated in FIG. 1 includes a vehicle seat assembly 10 mounted to a floor 12 of a motor vehicle. The vehicle seat assembly 10 includes a seat bottom 14, a seatback 16 pivotally connected to the seat bottom 14, and a seat track assembly 18 for forward and rearward movement of the vehicle seat assembly 10 relative to the vehicle floor 12. In the illustrated seat assembly 10, an operator manually moves a handlebar or “towel bar” 20 to actuate a first latch mechanism 22 for forward and rearward movement of the seat bottom 14 relative to the vehicle floor 12. An operator may also move a handle 24 to actuate a second latch mechanism 26 for pivotally moving the seatback 16 relative to the seat bottom 14. Several mechanisms for moving seat bottoms and seatbacks are known.

For example, U.S. patent application Ser. No. 10/904,201 to McCulloch et al. discloses a positive engagement latch for a vehicle seat. U.S. Pat. No. 6,832,815 to O'Conner discloses a seatback dump latch. U.S. Pat. No. 6,152,533 to Smuk discloses a sliding and folding seat mechanism. U.S. Patent Application Publication No. 2006/0055214 discloses seat assembly with a moveable seat and backrest.

### SUMMARY

The present application describes various embodiments of a seat adjusting assembly for adjusting a vehicle seat assembly having a seat bottom and a seatback. One embodiment of the seat adjusting assembly includes a first latch mechanism. The first latch mechanism is movable between a disengaged position wherein a seat bottom of a vehicle seat assembly is forwardly or rearwardly movable relative to the vehicle floor, and an engaged position wherein the seat bottom is prevented from moving relative to the vehicle floor. A second latch mechanism is movable between a disengaged position wherein a seatback of the vehicle seat assembly is forwardly or rearwardly pivotally movable relative to the seat bottom, and an engaged position wherein the seatback is prevented from pivotally moving relative to the seat bottom. An actuating mechanism is mechanically connected to the first and second latch mechanisms. The actuating mechanism is movable between a first actuating position wherein the first latch mechanism is in the disengaged position and the second latch mechanism is in the engaged position, and a second actuating position wherein the second latch mechanism is in the disengaged position and the first latch mechanism is in the engaged position.

Other advantages of the seat adjusting assembly will become apparent to those skilled in the art from the following detailed description, when read in light of the accompanying drawings.

### BRIEF DESCRIPTION OF THE DRAWINGS

FIG. 1 is a schematic side view of a prior art vehicle seat assembly.

FIG. 2 is a schematic side view of a first embodiment of a vehicle seat adjusting assembly.

FIG. 3 is a schematic side view of a second embodiment of the vehicle seat adjusting assembly illustrated in FIG. 2.

FIG. 4 is a schematic side view of a third embodiment of the vehicle seat adjusting assembly illustrated in FIG. 2.

FIG. 5A is a schematic side view of a second embodiment of the seat adjusting assembly handle illustrated in FIGS. 2 through 4.

FIG. 5B is a schematic top view of the second embodiment of the seat adjusting assembly handle illustrated in FIG. 5A.

FIG. 6 is a schematic side view of a third embodiment of the seat adjusting assembly handle illustrated in FIGS. 2 through 5B.

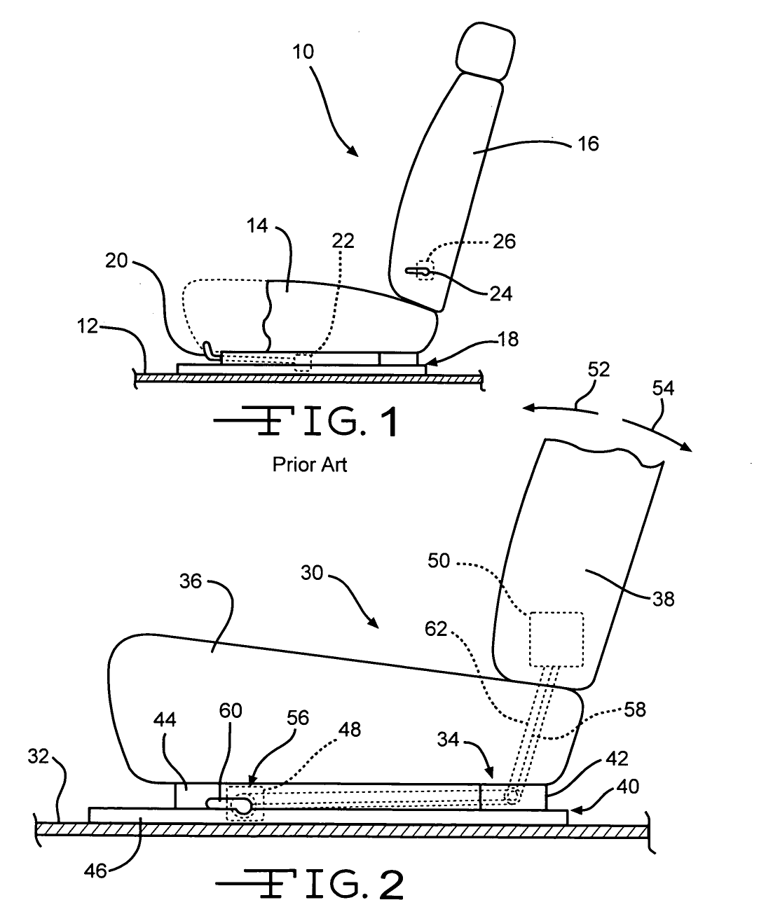

### DETAILED DESCRIPTION OF THE INVENTION

Referring now to the drawings, there is illustrated in FIG. 2 a schematic side view of a portion of a vehicle seat assembly 30 mounted to a floor 32 of a motor vehicle and having a first embodiment of a seat adjusting assembly, indicated generally at 34. The illustrated vehicle seat assembly 30 includes a seat bottom 36, a seatback 38 pivotally connected to the seat bottom 36, and a seat track assembly 40 for forward and rearward movement of the vehicle seat assembly 30 relative to the vehicle floor 32.

The seat track assembly 40 may include two track arrangements 42 (only one of which is shown in FIG. 2), each disposed proximate a side of the seat bottom 36. The illustrated track arrangements 42 include an upper track 44 and a lower track 46 that are configured to allow movement of one of the upper and lower tracks 44 and 46, relative to the other of the upper and lower tracks 44 and 46, respectively. In the illustrated embodiment, the upper track 44 is mounted to the underside of a frame (not shown) of the seat bottom 36, and the lower track 46 is mounted to the vehicle floor 32.

The illustrated seat track assembly 40 includes a first latch mechanism, schematically illustrated at 48, that is moveable between an unlocked or disengaged position and a locked or engaged position. In the disengaged position, the upper tracks 44 may move relative to the lower tracks 46. The seat bottom 36 is therefore one of forwardly and rearwardly movable relative to the vehicle floor 32. When the first latch mechanism 48 is in the engaged position, the upper tracks 44 may be prevented from moving relative to the lower tracks 46. The seat bottom 36 is therefore prevented from moving either forwardly or rearwardly relative to the vehicle floor 32. One example of such a seat track assembly 40 is described in co-assigned U.S. patent application Ser. No. 10/904,201, herein incorporated by reference. It will be understood that any other suitable seat track assembly may also be used.

As described in U.S. patent application Ser. No. 10/904,201, the first latch mechanism 48 is a positive engagement latch assembly, and includes one or more engaging members moveably attached to the upper track 44 and selectively engageable with the lower track 46, and an actuator for moving the engaging members.

The illustrated seat track assembly 40 further includes a second latch mechanism, schematically illustrated at 50, that is moveable between an unlocked or disengaged position and a locked or engaged position. In the disengaged position the seatback 38 may be moved pivotally forward, shown by the arrow 52 in FIG. 2, relative to the seat bottom 36. If desired, the seatback 38 may also be structured and configured to be reclined, or moved pivotally rearward, as shown by the arrow 54 in FIG. 2, relative to the seat bottom 36.

When the second latch mechanism 50 is in the engaged position, the seatback 38 is prevented from moving pivotally forward or pivotally rearward relative to the seat bottom 36. One example of such a latch mechanism 50 is described in co-assigned U.S. Pat. No. 6,832,815, herein incorporated by reference. It will be understood that any other suitable latch mechanism may also be used.

Referring again to FIG. 2, a first embodiment of an actuating mechanism is indicated generally at 34. In the illustrated embodiment, the actuating mechanism 56 is mechanically connected to the first latch mechanism 48. The actuating mechanism 56 is also mechanically connected to the second latch mechanism 50 by a cable link 58. The actuating mechanism 56 may include a handle 60. In the illustrated embodiment, the handle 60 is pivotally mounted to the frame of the seat bottom 36 and to the actuator for moving the engaging members of the first latch mechanism 48. If desired, the cable link 58 may be enclosed in a cable guide or sheath 62. The sheath 62 may be formed of any suitable material, such as aluminum, plastic, or any other metal, metal alloy, or non-metal. In the illustrated embodiment, the cable link 58 is attached at its upper end (as viewed in FIG. 2) to the second latch mechanism 50, and at its lower end (as viewed in FIG. 2) to the handle 60. It will be understood that the cable link 58 may follow any desired path through the vehicle seat assembly 30, such as the path illustrated in FIG. 2. Alternatively, the actuating mechanism 56 may be connected to the second latch mechanism 50 by any other suitable means, such as for example, a rigid or semi-rigid linkage bar. Such a linkage bar may be manufactured from any suitable material, such as for example, metal, metal alloys, or plastic.

In operation, a vehicle occupant may rotate the handle 60 in a first direction (clockwise or counter-clockwise) to a first actuating position such that the first latch mechanism 48 is moved from the engaged position to the disengaged position, and the second latch mechanism 50 remains in the engaged position. The actuator for moving the engaging members of the first latch mechanism 48 is thereby moved, moving the first latch mechanism 48 from the engaged position to the disengaged position, and allowing the seat bottom 36 to be moved forwardly and/or rearwardly relative to the vehicle floor 32.

Alternatively, a vehicle occupant may rotate the handle 60 in a second direction (the other of clockwise or counterclockwise) to a second actuating position such that the second latch mechanism 50 is moved from the engaged position to the disengaged position and the first latch mechanism 48 remains in the in the engaged position. In the disengaged position, the second latch mechanism allows the seatback 38 to be moved pivotally forward, shown by the arrow 52 in FIG. 2, and/or moved pivotally rearward, as shown by the arrow 54 in FIG. 2.

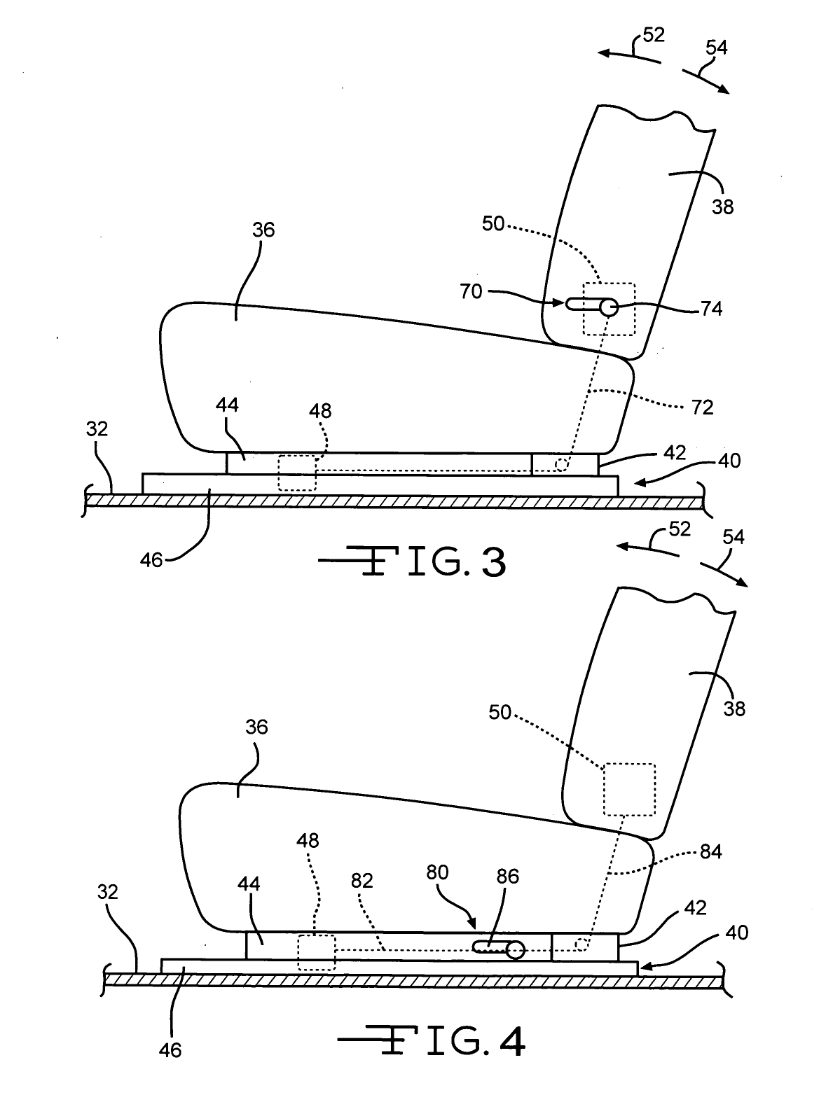

Referring now FIG. 3, and using-like reference numbers to indicate corresponding parts, there is illustrated a second embodiment of an actuating mechanism, indicated generally at 70. As shown therein, the actuating mechanism 70 is mechanically connected to the second latch mechanism 50. The actuating mechanism 70 is also mechanically connected to the first latch mechanism 48 by the cable link 72. The actuating mechanism 70 may include the handle 74. In the illustrated embodiment, the handle 74 is pivotally mounted to a frame of the seatback 38 and to the second latch mechanism 50. Although not illustrated, the cable link 72 may be enclosed in a cable guide or sheath, as disclosed herein above. In the illustrated embodiment, the cable link 72 is attached at its upper end (as viewed in FIG. 3) to the handle 74, and at its lower end (as viewed in FIG. 3) to the first latch mechanism 48.

In operation, a vehicle occupant may rotate the handle 74 in a first direction (clockwise or counter-clockwise) to a first actuating position such that the first latch mechanism 48 is moved from the engaged position to the disengaged position and the second latch mechanism 50 remains in the engaged position, allowing the seat bottom 36 to be moved forwardly and/or rearwardly relative to the vehicle floor 32.

Alternatively, a vehicle occupant may rotate the handle 74 in a second direction (the other of clockwise or counterclockwise) to a second actuating position such that the second latch mechanism 50 is moved from the engaged position to the disengaged position and the first latch mechanism 48 remains in the in the engaged position, allowing the seatback 38 to be moved pivotally forward rearward, as described herein above.

Referring now FIG. 4, and using like reference numbers to indicate corresponding parts, there is illustrated a third embodiment of an actuating mechanism, indicated generally at 80. As shown therein, the actuating mechanism 80 is mechanically connected to the first latch mechanism 48 by the cable link 82, and to the second latch mechanism 50 by the cable link 84. The actuating mechanism 70 may include the handle 86. In the illustrated embodiment, the handle 86 is pivotally mounted to a frame of the seat bottom 36 and is between, and spaced apart from, the first and second latch mechanisms 48 and 50, respectively. Alternatively, the handle 86 may be pivotally mounted to any desired location in the seat assembly 30, such as a frame of the seatback 38. Although not illustrated, the cable links 82 and 84 may be enclosed in sheaths as described herein above. In the illustrated embodiment, the cable link 82 is attached at its right end (as viewed in FIG. 4) to the handle 86, and the cable link 84 is attached at its left end (as viewed in FIG. 4) to the handle 86. The cable link 82 is further attached at its left end (as viewed in FIG. 4) to the first latch mechanism 48. The cable 84 is further attached at its right end (as viewed in FIG. 4) to the second latch mechanism 50.

In operation, a vehicle occupant may rotate the handle 86 in a first direction (clockwise or counter-clockwise) to a first actuating position such that the first latch mechanism 48 is moved from the engaged position to the disengaged position and the second latch mechanism 50 remains in the engaged position, allowing the seat bottom 36 to be moved forwardly and/or rearwardly relative to the vehicle floor 32.

Alternatively, a vehicle occupant may rotate the handle 86 in a second direction (the other of clockwise or counterclockwise) to a second actuating position such that the second latch mechanism 50 is moved from the engaged position to the disengaged position and the first latch mechanism 48 remains in the in the engaged position, allowing the seatback 38 to be moved pivotally forward rearward, as described herein above.

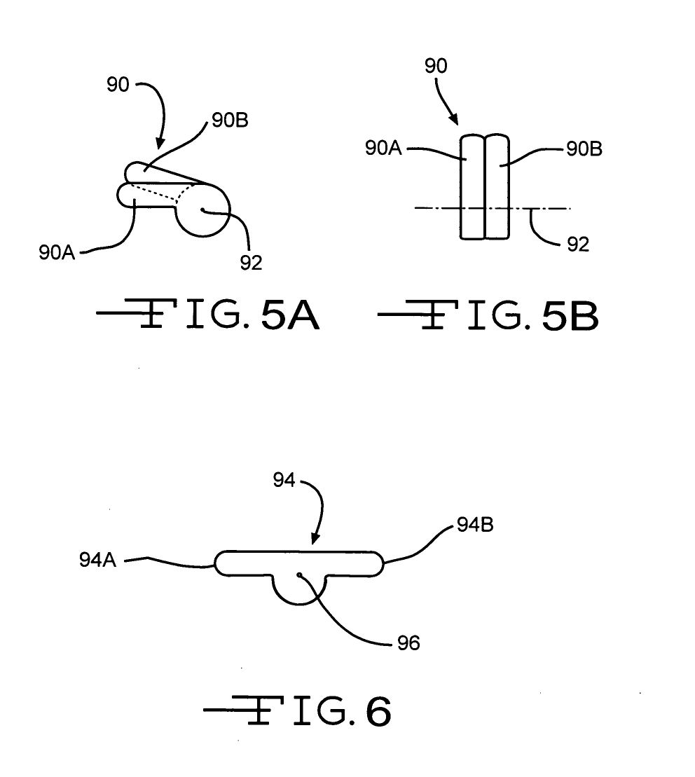

Referring now FIGS. 5A and 5B, there is illustrated a second embodiment of the handle, indicated generally at 90. The handle 90 includes a first handle portion 90A and a second handle portion 90B mounted about a handle pivot axis 92. The handle 90 may be used in lieu of the handles 60, 74, and 86, in a manner described in detail herein above. In use, the first handle portion 90A may be operatively connected to the first or second latch mechanisms 48 and 50, respectively, such as with the cable links 58, 72, and 82 or 84, and the second handle portion 90B may be operatively connected to the other of the first or second latch mechanisms 48 and 50, respectively, such as with the cable links 58, 72, and the other of the cable links 82 or 84.

Referring now FIG. 6, there is illustrated a third embodiment of the handle, indicated generally at 94. The handle 94 includes a first handle portion 94A and a second handle portion 94B mounted about a handle pivot axis 96. In the illustrated embodiment, the first and second handle portions 94A and 94B are disposed at about 180 degrees apart. It will be understood however, that the first and second handle portions 94A and 94B may be disposed at any desired location relative to one another. The handle 94 may be used in lieu of the handles 60, 74, and 86, in a manner described in detail herein above.

The principle and mode of operation of the seat adjusting assembly have been described in its various embodiments. However, it should be noted that the seat adjusting assembly described herein may be practiced otherwise than as specifically illustrated and described without departing from its scope.

What is claimed is:

1. A seat adjusting assembly for adjusting a vehicle seat assembly having a seat bottom and a seatback, the seat adjusting assembly comprising:
a first latch mechanism movable between a disengaged position wherein a seat bottom of a vehicle seat assembly is one of forwardly and rearwardly movable relative to the vehicle floor, and an engaged position wherein said seat bottom is prevented from moving forwardly and rearwardly relative to said vehicle floor;
a second latch mechanism movable between a disengaged position wherein a seatback of said vehicle seat assembly is one of forwardly and rearwardly pivotally movable relative to said seat bottom, and an engaged position wherein said seatback is prevented from pivotally moving forwardly and rearwardly relative to said seat bottom; and
an actuating mechanism mechanically connected to said first latch mechanism and said second latch mechanism, said actuating mechanism being movable between a first actuating position wherein said first latch mechanism is in said disengaged position and said second latch mechanism is in said engaged position, and a second actuating position wherein said second latch mechanism is in said disengaged position and said first latch mechanism is in said engaged position.

2. The seat adjusting assembly according to claim 1, wherein said actuating mechanism includes a handle movable between a first handle position and a second handle position, said first handle position corresponding to said first actuating position and said second handle position corresponding to said second actuating position.

3. The seat adjusting assembly according to claim 2, wherein said handle of said actuating mechanism is mounted to one of an inboard and an outboard side of said seat bottom.

4. The seat adjusting assembly according to claim 2, wherein said handle of said actuating mechanism is mounted to one of an inboard and an outboard side of said seatback.

5. The seat adjusting assembly according to claim 2, wherein said actuating mechanism further includes a cable link mechanically connecting said actuating mechanism to at least one of said first latch mechanism and said second latch mechanism.

6. The seat adjusting assembly according to claim 2, wherein said actuating mechanism further includes a first cable link mechanically connecting said actuating mechanism to said first latch mechanism and a second cable link mechanically connecting said actuating mechanism to said second latch mechanism.

7. The seat adjusting assembly according to claim 2, wherein said actuating mechanism further includes a linkage bar mechanically connecting said actuating mechanism to at least one of said first latch mechanism and said second latch mechanism.

8. The seat adjusting assembly according to claim 1, wherein said actuating mechanism includes a first handle pivotally movable about a pivot axis to a first handle position, and a second handle pivotally movable about said pivot axis to a second handle position, said first handle position corresponding to said first actuating position and said second handle position corresponding to said second actuating position.

9. The seat adjusting assembly according to claim 1, wherein said actuating mechanism is mounted to one of an inboard and an outboard side of said seat bottom.

10. The seat adjusting assembly according to claim 9, wherein said actuating mechanism is mounted to a frame of said seat bottom.

11. The seat adjusting assembly according to claim 1, wherein said actuating mechanism is mounted to one of an inboard and an outboard side of said seatback.

12. The seat adjusting assembly according to claim 11, wherein said actuating mechanism is mounted to a frame of said seatback.

13. The seat adjusting assembly according to claim 1, wherein said actuating mechanism is mounted to a vehicle floor.

14. The seat adjusting assembly according to claim 1, wherein said actuating mechanism is mounted to a vehicle trim panel.

15. A seat adjusting assembly for adjusting a vehicle seat assembly having a seat bottom and a seatback, the seat adjusting assembly comprising:
a first latch mechanism movable between a disengaged position wherein a seat bottom of a vehicle seat assembly is one of forwardly and rearwardly movable relative to the vehicle floor, and an engaged position wherein said seat bottom is prevented from moving forwardly and rearwardly relative to said vehicle floor;
a second latch mechanism movable between a disengaged position wherein a seatback of said vehicle seat assembly is one of forwardly and rearwardly pivotally movable relative to said seat bottom, and an engaged position wherein said seatback is prevented from pivotally moving forwardly and rearwardly relative to said seat bottom; and
an actuating mechanism connected to said first latch mechanism and said second latch mechanism, said actuating mechanism having at least one cable link connecting said actuating mechanism to at least one of said first latch mechanism and said second latch mechanism, said actuating mechanism being mounted to a frame of one of said seat bottom and said seatback, said actuating mechanism being movable between a first actuating position wherein said first latch mechanism is in said disengaged position and said second latch mechanism is in said engaged position, and a second actuating position wherein said second latch mechanism is in said disengaged position and said first latch mechanism is in said engaged position.

16. The seat adjusting assembly according to claim 15, wherein said actuating mechanism includes a handle movable between a first handle position and a second handle position, said first handle position corresponding to said first actuating position and said second.

17. The seat adjusting assembly according to claim 15, wherein said actuating mechanism is mounted to one of an inboard and an outboard side of said seatback.

18. The seat adjusting assembly according to claim 15, wherein said actuating mechanism is mounted to a vehicle floor.

19. The seat adjusting assembly according to claim 15, wherein said actuating mechanism is mounted to a vehicle trim panel.

20. A seat adjusting assembly for adjusting a vehicle seat assembly having a seat bottom and a seatback, the seat adjusting assembly comprising:
a first latch mechanism movable between a disengaged position wherein a seat bottom of a vehicle seat assembly is one of forwardly and rearwardly movable relative to the vehicle floor, and an engaged position wherein said seat bottom is prevented from moving forwardly and rearwardly relative to said vehicle floor;
a second latch mechanism movable between a disengaged position wherein a seatback of said vehicle seat assembly is one of forwardly and rearwardly pivotally movable relative to said seat bottom, and an engaged position wherein said seatback is prevented from pivotally moving forwardly and rearwardly relative to said seat bottom; and
an actuating mechanism connected to said first latch mechanism and said second latch mechanism, said actuating mechanism having at least one linkage bar connecting said actuating mechanism to at least one of said first latch mechanism and said second latch mechanism, said actuating mechanism being mounted to a frame of one of said seat bottom and said seatback, said actuating mechanism being movable between a first actuating position wherein said first latch mechanism is in said disengaged position and said second latch mechanism is in said engaged position, and a second actuating position wherein said second latch mechanism is in said disengaged position and said first latch mechanism is in said engaged position.
